(19) United States
(12) Patent Application Publication
(10) Pub. No.: US 2015/0112739 A1
(43) Pub. Date: Apr. 23, 2015

(54) METHOD AND SYSTEM FOR MONETIZATION OF APPLICATIONS AND SERVICES IN COMMUNICATION DEVICES

(71) Applicant: Agreeya Mobility, Inc., Burnaby (CA)

(72) Inventors: Chirag Pathak, Burnaby (CA); Jussi Leino, Burnaby (CA); Bernard Wei, Burnaby (CA); Thomas Winkler, Burnaby (CA); Ashwini Bharadwaj, Burnaby (CA)

(21) Appl. No.: 14/515,521

(22) Filed: Oct. 16, 2014

Related U.S. Application Data
(60) Provisional application No. 61/893,113, filed on Oct. 18, 2013.
(60) Provisional application No. 61/896,284, filed on Oct. 28, 2013.

(51) Int. Cl. G06Q 10/06; G06F 9/44

(52) U.S. Cl. CPC G06Q 10/063; G06F 8/30
USPC 705/7.11

(57) ABSTRACT

A method and system for monetization of an application is provided. The method includes identifying one or more monetizing event in the application. Further, the method includes modifying one or more trigger points in the application based on the identified monetizing event. Each trigger point is associated with a rule for monetizing the application in response to an activation of the trigger point. Furthermore, the method includes building an application package including the modified trigger points.

### PRIORITY DETAILS

The present application is based on, and claims priority from, U.S. Application No. 61/893,113, filed on 18 Oct., 2013 and U.S. Application No. 61/896,284, filed on 28 Oct., 2013, the disclosure of which is hereby incorporated by reference herein.

### TECHNICAL FIELD

The embodiments generally relate to the field of monetization of applications and services. More particularly relates to a platform for dynamically inserting trigger points to improve monetization of the applications and services.

### BACKGROUND

With the evolution of mobile computing, mobile services and cloud-based services, developers or providers of such services (For example, Independent Software Vendor (ISV)) are aiming to monetize such services and applications. Monetization can follow a multitude of models, with the most prevalent models being a one-time charge, a recurring subscription, up-front charge, free trial period, in-app purchase and multiple functionality levels that may not necessarily be mutually exclusive.

The ISVs need to establish a method of payment for such functionality and services, in order to successfully monetize them. Payments are usually handled by payment providers, and an ISV may go through the steps of integrating a payment provider's enablers directly into their application or service, or to offer the application or service via a distributor that takes care of the monetization.

The conventional systems and methods for monetizing the applications require the application publisher to provide the monetization requirements to an application developer. The monetization pattern is then hard coded within the application during the application development stage. The conventional methods and systems provide a static approach towards the monetization. However, for the ISV, the primary challenge in optimizing their Return-on-Investment (ROI) for their application or service is to optimize monetization, such that users who are evaluating or using the application or service are converted into paying users with the most expensive payment plan. In order to achieve this, the monetization patterns need to be modified from time to time for converting the potential users into revenue by enticing them to opt for the premium payment plans.

When utilizing a third-party marketplace or even when utilizing a payment provider directly, the ISVs have to use limited sets of tools and Application Programming Interface (API) in order to effect the monetization of their application or service. Modification in the already implemented monetization patterns requires the ISVs to re-write the code of the application or service using the APIs, and business rules. As the APIs and business rules are typically rigid and require a significant effort and time to comply with, the ISVs often can only achieve a very poor level of optimization of monetization. Further, as the maximum reach to the potential user audience is achieved by distributing multiple marketplaces and multiple payment providers, an ISV either has to invest into the maintenance and optimization of multiple variants of the application or service, or forego a monetization opportunity.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Those skilled in the art will appreciate that the summary is illustrative only and is not intended to be in any way limiting.

Accordingly the embodiments provide a method for monetization of an application. The method comprising identifying at least one monetizing event in the application. The method includes modifying at least one trigger point in the application based on the at least one identified monetizing event. At least one trigger point is associated with at least one rule to monetize the application in response to an activation of the at least one trigger point. The method further includes building an application package including the at least one modified trigger point.

Accordingly the embodiments provide a system for monetization of an application. The system comprises a server configured to identify at least one monetizing event in the application. The server is configured to modify at least one trigger point in the application based on the at least one identified monetizing event. At least one trigger point is associated with at least one rule to monetize the application in response to an activation of the at least one trigger point. Further, the server is configured to build an application package including the at least one modified trigger point.

Accordingly the embodiments provide server for monetization of an application. The server is configured to identify at least one monetizing event in the application. The server is further configured to modify at least one trigger point in the application based on the at least one identified monetizing event. At least one trigger point is associated with at least one rule to monetize the application in response to an activation of the at least one trigger point. Further, the server is configured to build an application package including the at least one modified trigger point.

Accordingly the embodiments provide a computer program product comprising computer executable program code recorded on a computer readable non-transitory storage medium, the computer executable program code when executed, causing the actions including identifying at least one monetizing event in the application. The computer executable program code when executed, causing further actions including modifying at least one trigger point in the application based on the at least one identified monetizing event. At least one trigger point is associated with at least one rule to monetize the application in response to an activation of the at least one trigger point. The computer executable program code when executed, causing further actions including building an application package including the at least one modified trigger point.

Many of the features will be explained below with reference to the following detailed description considered in connection with the accompanying drawings.

### BRIEF DESCRIPTION OF FIGURES

This embodiment is illustrated in the accompanying drawings, throughout which like reference letters indicate corresponding parts in the various figures. The embodiments herein will be better understood from the following description with reference to the drawings, in which:

FIG. 1 illustrates an overview of a system providing a monetization platform, according to the embodiments as disclosed herein;

FIG. 2 is illustrates various modules of a server, according to the embodiments as disclosed herein;

FIG. 3 illustrates detailed view of a controller component for building an application package, according to the embodiments as disclosed herein;

FIG. 4 illustrates various operations of a rule engine, according to the embodiments as disclosed herein;

FIG. 5 illustrates a licensing system for an application embedded in the application package; according to the embodiments as disclosed herein;

FIG. 6 is a flow diagram illustrating a method for monetization of the application or service, according to the embodiments as disclosed herein;

FIG. 7 is a use case scenario illustrating various operations performed to optimize the monetization, according to the embodiments as disclosed herein; and

FIG. 8 illustrates a computing environment implementing the method and system for method for monetization of an application or service, according to embodiments disclosed herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments disclosed herein provide a system and method for monetization of an application or a service. A server can be configured to insert trigger points into the application or the service and builds an application package for the application or the service. The application package embeds together an interceptor component, and a licensing enabler component along with the application or the service. Each trigger point corresponds to a monetization event identified in the application or the service. Further, the server can be configured to associate a rule (monetization rule) with each trigger point. Each rule is associated with a metadata such as and payment plans for the corresponding monetization event. The rules associated with the trigger points in the application or the service and the corresponding Metadata form a monetization pattern in the server for the application or the service. Unlike the conventional systems and methods where the rules and the payment plans are hard coded in the app, the proposed method and system dynamically defines and downloads the rules from the rule engine, in real time, in response to an activation of the trigger point. The application is interrupted when the trigger point is activated, the corresponding rule is downloaded and is evaluated locally to notify a user of the application or the service about the payment plans for current level of the application or the service.

Unlike, the existing systems and methods, the proposed method and system allow an application owner (For example, an Independent Software Vendor (ISV)) to modify the rules corresponding to the trigger points. Options are provided for selectively deactivating or disabling the already inserted trigger points, selectively re-activating or enabling the trigger points. Additional trigger points can be inserted by identifying monetization events based on the information provided by the application owner. A flexible platform independent monetization approach allows the ISV to optimize the monetization results by:
Selectively defining more trigger points than conservatively necessary;
Setting a certain set of associated rules and price plans, measuring the conversion rates for the given set of rules and price plans;
Comparing the conversion rates with alternatives;
Modifying the rules and price plans dynamically, without ever changing the application or the services.

In an embodiment, the server provides assistance to the ISV by publishing the application package at multitude geographical locations in one or more application stores. Further, the server may provide the ISV with location based current user trends that assist the ISV to change the monetization pattern by dynamically modifying the rules for the application ort the service at selected application stores (where the application is published).

Unlike conventional systems and methods that need the ISV analyze location based user trends, modify the application for desired monetization pattern and then re-publish the application or the service in the application store the proposed method and system provides a simple single point approach. The method and system configure the server to provide analysis of location based user trends to the ISV, allows the ISV to modify the monetization pattern, and re-publish the application or the service at the application stores as instructed by the ISV.

Throughout the description the term application (app) is referred for the term ‘the application or the service’

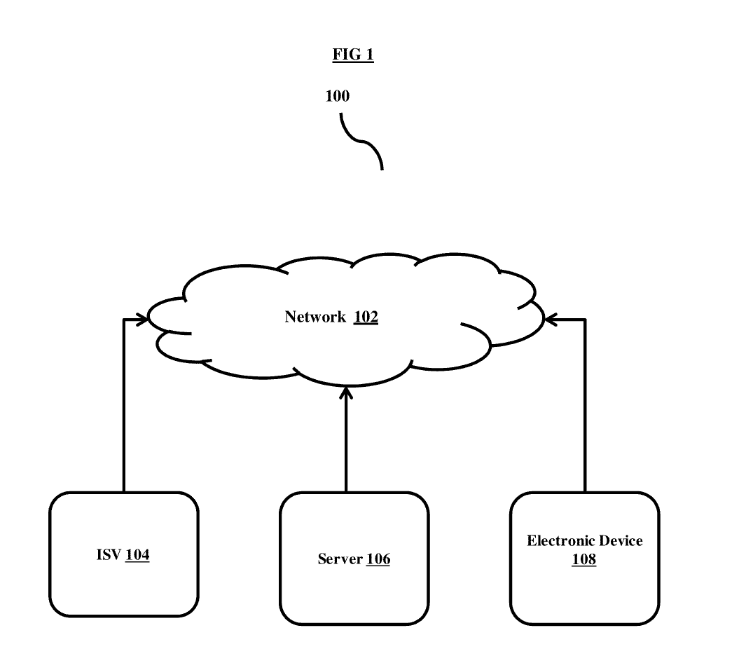

Referring now to the drawings, and more particularly to FIGS. 1 through 8, where similar reference characters denote corresponding features consistently throughout the figures, there are shown preferred embodiments.

FIG. 1 illustrates an overview of a system 100 providing a monetization platform, according to the embodiments as disclosed herein. In an embodiment, the system 100 includes a network 102, an ISV 104, a server 106 and an electronic device 108. The network 102 provides the connectivity to enable communication among the ISV 104, the server 106 and the electronic device 108. The server 106 can be configured to receive the app from the ISV 104, identify monetization events in the application, and insert trigger points for the identified monetization events. The server 106 can be configured to insert an interceptor component and a licensing enabler component to the app to build an application package.

In an embodiment, the server 106 can be configured to publish the application package in the application store. The electronic device 108 can then download the application package from the application store. During the run time of the app on the electronic device 108, for every enabled trigger point, the app execution may be interrupted. The application package communicates with the server 106, through the network 102 and dynamically accesses and evaluates the corresponding rule associated with the active trigger point. Based on the evaluation result of the corresponding rule the monetization pattern defining the license agreement and/or the payment plans is notified to the user. On acceptance of the license agreement the user may, for example, allowed to approach next level and the interrupted app continues execution.

The FIG. 1 show a limited overview of the system 100 but, it is to be understood that other embodiments are not limited thereto. Further, the system 100 can include and communicate with internal or external network elements for optimizing the monetization pattern along with other hardware or software components to communicate with each other. For example, the component can be, but not limited to, a process running in the controller or processor, an object, an executable process, a thread of execution, a program, or a computer. By way of illustration, both an app running on a device and the device itself can be a component.

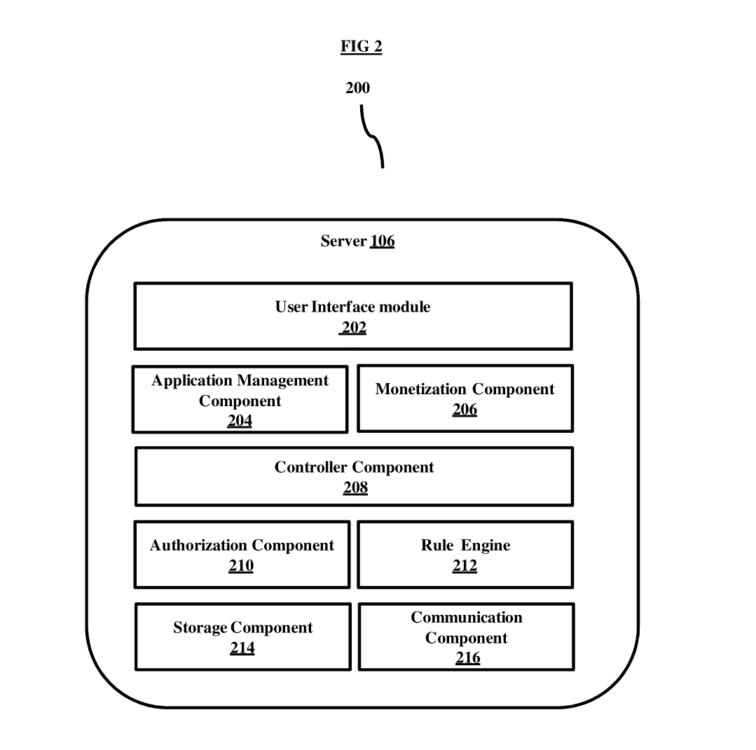

FIG. 2 is illustrates various modules 200 of a server 106, according to the embodiments as disclosed herein. In an embodiment, the server 106 can be configured to include a user interface module 202, an application management component 204, a monetization component 206, a controller component 208, an authorization component 210, a rule engine 212, a storage component 214, and a communication component 216. The user interface module 202 can be configured to allow the ISV 104 to interact with the application management module 204 to upload the app and/or information from the ISV 104 for identifying the monetization events. The application management component 204 can be configured to provide the ISV 104 with the trigger points identified by the controller component 208. The ISV can then activate or deactivate the trigger points for the app to be uploaded to one or more selected application stores. The monetization events are based on the monetization component 206 configured to extract the monetization information provided by the ISV 104 and send it to the controller component 208.

In an embodiment, the monetizing event in identified based on one or more parameters associated with the app including but not limited to an application type, a content presented, a contextual datum that is associated with the content presented, user interface elements, and user interface functions.

The controller component 208 can be configured to create the application package for the uploaded app by embedding the interceptor component and the license enabler component provided by the authorization component 210. The controller component can be configured to build the application package around the app inserted with trigger points and associating each trigger point to a unique rule. The rules are defined and dynamically modified by the ISV 104 in the rule engine 212. The storage component 214 can be configured to store the app uploaded by the ISV 104 or the built application package. The communication component 216 allows the server 106 to communicate with other elements of system 100 such as the ISV 104 and the electronic device 106.

The FIG. 2 show a limited overview of the server 106 but, it is to be understood that other embodiments are not limited thereto. The labels provided to each module or component is only for illustrative purpose and does not limit the scope of the embodiment. Further, the one or more modules can be combined or separated to perform the similar or substantially similar functionalities without departing from the scope of the embodiment. Furthermore, the server 106 can include various other modules or components interacting locally or remotely along with other hardware or software components to communicate with each other. For example, the component can be, but not limited to, a process running in the controller or processor, an object, an executable process, a thread of execution, a program, or a computer. By way of illustration, both an app running on a server and the server itself can be a component.

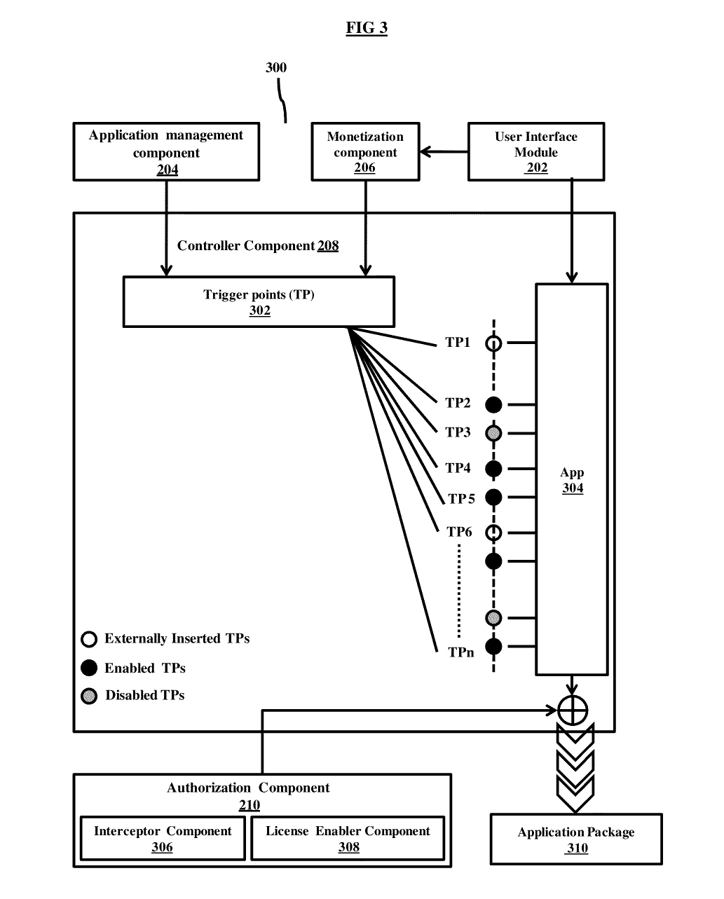

FIG. 3 illustrates detailed view of the controller component 208 to build an application package, according to the embodiments as disclosed herein. In an embodiment, the controller component 208 can be configured to receive the uploaded app 304 by the ISV 104 through the user interface module 202. The controller can be configured to identify one or more monetizing events in the app 304 and insert corresponding trigger points 302 (TP1 to TPn) for the identified monetization events.

The controller component 208 can be configured to identify the monetizing events by searching through the app 304 based on the monetization component 206 received from the ISV 104. For example, if in a mobile game, advancement to game level 6 is a monetizable event, then the ISV 104 provides information indicating the monetizing event. The controller component 208 can be configured to identify the monetizing event and insert trigger point to mark this event. In an example, if in a mobile service, usage of an advanced function X is a monetizable event then a corresponding trigger point is inserted to mark the event. The insertion of the trigger points can be using an automatic insertion mode or an assisted insertion mode.

In the automatic insertion mode, the main part of the app 304 is modified to insert trigger points for every invocation of the app 304. This main part would typically be an initial user interface presented at launch of the app, depending on the operating system.

In the assisted insertion mode, the controller component 208 searches the app 304 for monetization events typically, main user interface functions or user interface elements such as main function buttons, screens and the like to insert trigger points at these identified monetizing events. The controller component 208 presents a list of the monetizing events to the ISC 104 allowing the ISV 104 to select those monetizing events that suit the ISV's business need. These monetizing points are then instrumented as trigger points 302, whereas the other identified monetizing events are ignored.

In an embodiment, the ISV 104 can define additional trigger points using than being constrained by user interface elements. Those additional trigger points can be associated to the structure of the app 304 into asset bundles (for example, assets clustered into certain sub-directories within the app) or they can be associated with certain online Uniform resource Locators (URLs) being accessed by the app 304. Some example trigger points are shown in the figure that can be selectively disabled (TP3) and enabled (TP2, TP4, TP5 and TPn).

In an embodiment, the ISV 104 can define monetizing events for insertion of additional trigger points that were not automatically identified by the controller component 204 while searching through the app 304. Each trigger point is then associated with a corresponding rule generated by the rule engine based on the information received from the ISV 104. The rules are associated with corresponding payment plans to define the monetization pattern for the corresponding trigger point. For example the automatic insertion mode, the associated rule can be to offer 30 days of free usage, before the paid payment plan applies. For example, an app instrumented in such a way could be used for free for 30 days, after which time the up-sell dialog for the paid plan is presented to the user, and further usage of the app 304 is only possible after successful payment of this plan. In the automatic insertion mode, the ISV 104 can control, the time period or frequency for the free trial (e.g., 30 days, or 5 minutes, or 5 times, or 0 minutes), as well as the payment plan for further usage.

Upon insertion of the trigger points, associating the corresponding rules and defining the payment plans, the system 100 configures the server to build an application package 310 for the app 304. The authorization component 210 can be configured to add an interceptor component 306 and a license enabler component 308 to build the application package 310. The application package 310 also includes a table of all trigger points. The interceptor component 306 and the license enabler component are introduced into the app 304 without the need for the ISV to change the app 304 or to use special Application Programming Interfaces (APIs).

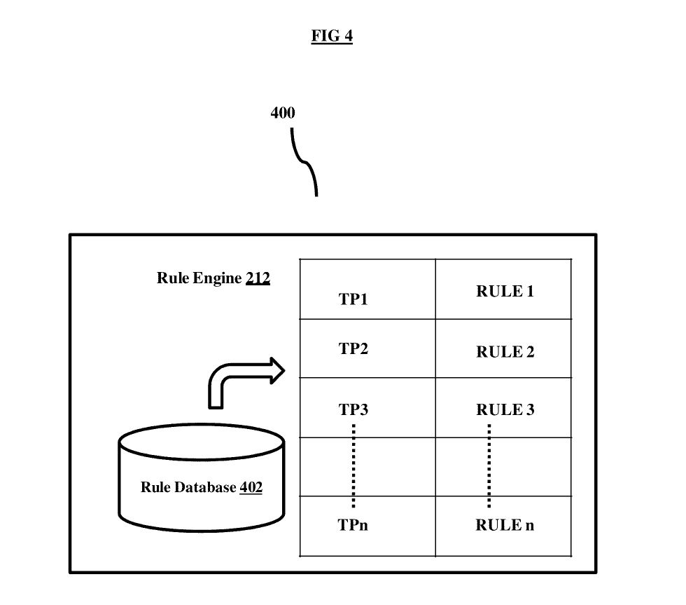

FIG. 4 illustrates various operations 400 of the rule engine 212, according to the embodiments as disclosed herein. In an embodiment, the rule engine 212 includes a rule data base 402. The rule data base stores the rules generated for the corresponding trigger points based on the information for rule provided by the ISV 104. The controller component 208 is then configured to associate each rule with corresponding trigger point as shown.

A rule associated with the corresponding trigger point is fired when the trigger point is activated during the app run-time. For example,
a. Trigger point A→fires Rule X
b. Trigger point B→fires Rule X
c. Trigger point C→fires Rule Z

The rule X defined in the rule base 402 as provided by the ISV can be:
i. 1 day free trial period for the same user across all devices
ii. Executed after either trigger A or B are fired at least once after the trial period
iii. Up-sell to Feature Package 1

Complex rules are de-composed into more simple rules, which in turn are separated into components embedded with the app 304 and the components stored on the back-end (server 106), in order to achieve the highest performance at app 304 runtime while maintaining the highest flexibility. For example, the overall rule can be that a premium package with a higher feature/price-level applies after (1) the user has used the app 304 or at least 5 minutes, (2) the user has used any two of three premium functions at least once. Then the app 304 can be instrumented with trigger points on all the premium functions and with a free trial period of 5 minutes. A check for the above factors is executed by the licensing enabler component 308 locally on the electronic device 108, which are very simple rules that can be checked in real-time. However, if any of the trigger point is executed after the trial period, the overall rule is downloaded from the back-end (rule engine 212) and evaluated. Thus, in this case described, the usage of all the three premium functions is evaluated against the rule.

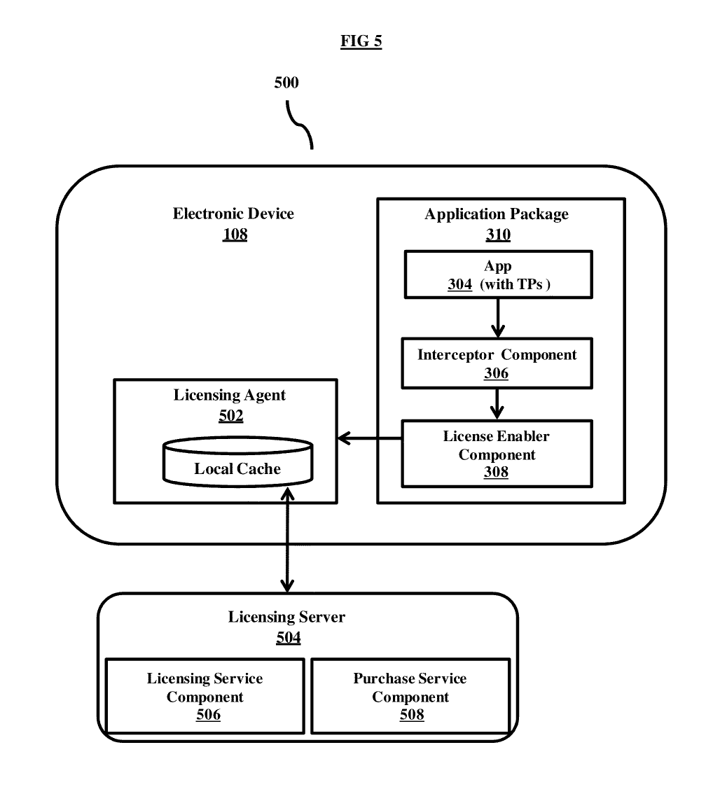

FIG. 5 illustrates a licensing system 500 for the app 304 embedded in the application package 310, according to the embodiments as disclosed herein. In an embodiment the licensing system 500 includes the electronic device with the application package 310, a licensing agent 502 on the electronic device 108 and a back end licensing server 504 that includes a licensing service component 506, and a purchase service component 508.

In an embodiment, the licensing server 504 may be integral part of the server 106 or can be an individual entity in the network 102 supporting the monetization platform disclosed.

The interceptor component 306 is embedded into the application package 310 of the app 304 or in an operating system of the electronic device 108 such that the interceptor 306 can monitor any event that corresponds to the trigger point.

The interceptor component 306 monitors the app 304 execution to first check for the trigger point. In case an activated trigger point is identified indicating the detection of the activated trigger point and, if triggered positively (the trigger point is enabled) leads to executing the associated rule. For a negative trigger point (disabled trigger point) being detected or in situation of undetected trigger point the app 304 continues uninterrupted execution to identify the next trigger point.

If the interceptor component 306 detects enabled trigger point, the interceptor component can be configured invoke the licensing enabler component 308. The license enabler component 308 can be configured to evaluate the rule and determine whether to return the app flow to the intercept component 306 or establish communication to the licensing agent 502. The rule is executed locally, but it is fetched dynamically from the back-end (server 106).

The integrity of the app 304 can be protected by a trusted app signature, without which the app would not be executable.

The license agent 502 is typically configured to provide a secure and trusted service on the same platform as the app 304, which can be contacted by the app's licensing enabler component 308 in a fast and inexpensive manner. However, the licensing agent 502 must be trustable by the licensing enabler component 308. Also, the license server 504 must be able to trust the licensing agent 502.

In an embodiment, a trust chain is established using either Public Key Infrastructure (PKI) infrastructure with known certificates as trust anchors or an equivalent security and trust chain framework.

The licensing agent 502 maintains a local cache on the electronic device 108 or node (location) where the current app 304 runs. The local cache maintains a history of trigger points, rules, users, license certificates; payment plans etc so that subsequent evaluations of rules do not require expensive network operations. If the license agent 502 is evaluating a rule/trigger combination and unable to find the relevant metadata in its local cache, it establishes a secure connection to the licensing server 504. The licensing server 504 can be configured to provide the details of a given rule and payment plans to the licensing agent 502 allowing execution of the rule. The rule is also written to the local cache of the licensing agent 502.

If the rule indicates that the trigger was valid and a given payment plan must be paid for, then in an embodiment, the licensing agent 502 displays a dialog to the user to inform the user that the current function is part of a premium plan of the app or service. The licensing agent fetches the associated up-sell screen, along with the related price plans/price schemes. In the screen, the user can either choose one of the plans, or choose to cancel the function (i.e. to not pay and therefore not use the function), or choose to attempt a license restore (based on a log-in of the user into a common ID management framework used by the system 100, which allows the retrieval of past licenses that may have been obtained for this user on another user interface such as a web or another device.

Once payment was successful, the licensing server 504 records the entitlements the user has paid for with the current purchase and issue a license that grants access to those entitlements.

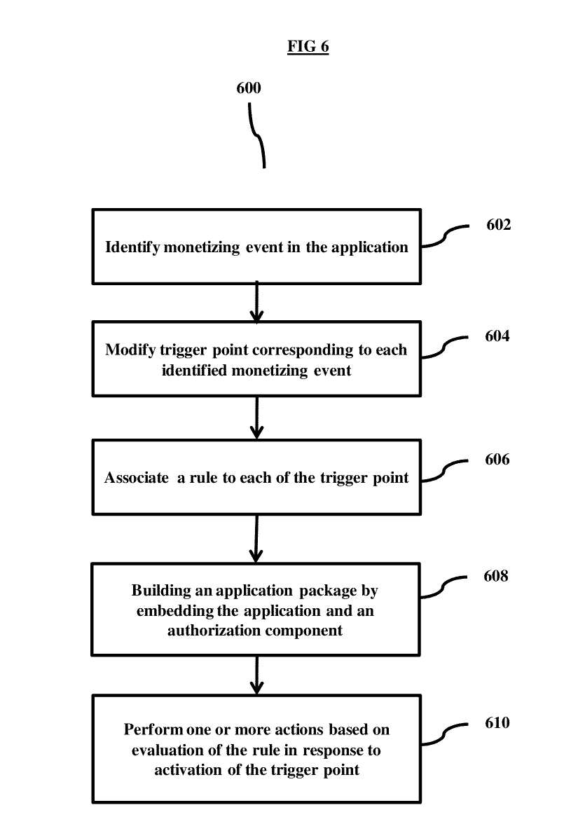

FIG. 6 is a flow diagram illustrating a method 600 for a monetization of the app, according to the embodiments as disclosed herein. The method 600 and other description provide a basis for a control program which can be easily implemented using a micro roller, a microprocessor, or any computer readable storage medium.

In an embodiment, at step 602, the method 600 includes identifying monetization event in the app. The method 600 allows the controller component 208 to scan or parse the app to identify the monetizing events based on one or more parameters associated with the app or service. The parameters can include, for example, but not limited to, an app type, a content presented, operating system platform of the electronic device, a contextual datum that is associated with the content presented, user interface elements, user interface functions, and the like.

At step 604, the method 600 includes modifying trigger point corresponding to each identified monetizing event. For each identified monetizing event, the method 600 allows the controller component 208 to modify the trigger point in the app or service, such as to remodel the monetization pattern.

In an embodiment, modifying the trigger point includes enabling one or more trigger points, disabling one or more trigger points, inserting one or more trigger points, deleting one or more trigger points, reordering one or more trigger points, rewriting one or more trigger points, remodeling one or more trigger points, altering one or more trigger points, and the like.

At step 606, the method 600 includes associated one or more rules to each trigger point. Based on the analysis of the usage trend or monetization opportunity, the method 600 allows the controller component 208 to associate a rule to each of the trigger point.

At step 608, the method 600 includes building an application package by embedding the app and an authorization component. The method 600 allows the controller component 208 to build the application package 310 by embedding the app 304 along with the interceptor component 306 and the license enabler component 308.

At step 610, the method 600 includes performing one or more actions in response to activation of the trigger point during run time of the app. Whenever the app or service package is executed by the electronic device 108 or any node, the method 600 allows the application package 310 to perform one or more actions in accordance to the rule being associated with the corresponding trigger point. The associated rule can be dynamically defined and downloaded in response to activation of the trigger point, in run time, of the app. The activation of the trigger point is monitored by the interceptor component 306. Once the trigger point is activated, the method 600 configures the server 106 to provide the corresponding rule along with the Metadata to the node or the electronic device 108.

In an embodiment, the meta data is associated with a feature/Price Packages that are stored on the server 106 and include:
d. Feature package name
e. Possible subscription options
   i. One-time payment for life ownership
   ii. Annual subscription
   iii. Monthly subscription
f. Associated pricing for each subscription option
g. List of all trigger rules

Up-Sell Screen Information.

In an embodiment the method 600 includes performing metering around the trigger points. For example:
h. A trigger point can have associated behavior that can be used to achieve metering, namely:
   i. Time-delay: once a trigger point is reached, a timer is started and only once the timer is up, the rule associated with the trigger point is fired. This is useful for example to achieve behaviors like “5 minutes of free usage of feature X” or “pay by play time” in a game.
   ii. Counter activated: The trigger point only fires after N times. This is useful for example to achieve behaviors like “3 free printouts” or “pay for every 10 messages sent”.
   iii. Trigger point-to-trigger point: Trigger point is only activated after another trigger point is already fired. This is useful to achieve more complex behaviors.
   iv. End date trigger point: The trigger point is activated at or after a specific date and time. This is useful to limit the usage of free trials (e.g., “app can be used for free until end of November”)

The various actions, acts, blocks, steps, and the like in the method 600 may be performed in the order presented, in a different order or simultaneously. Further, in some embodiments, some actions, acts, blocks, steps, and the like may be omitted, added, modified, skipped, and the like without departing from the scope of the embodiment.

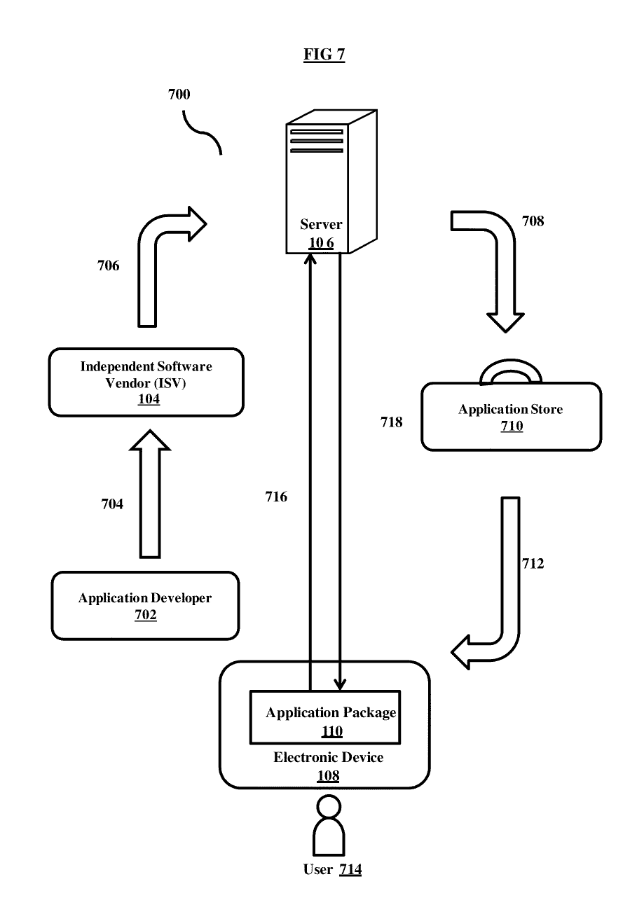

FIG. 7 is a use case scenario 700 illustrating various operations performed to optimize the monetization, according to the embodiments as disclosed herein. In the use case scenario 700 the application developer 702 develops and at 704 provides the app 304 to the ISV 104. At 706, the ISC 104 uploads the app 304 in the server 106. The server 106 builds the application package 310 for the app 304 and at 708 publishes the application package 310 on to the application store 710. Further, at 712, a user 706 can download the application package 310 on his/her electronic device 108. Upon activation of app 304, the interceptor component 306 monitors the execution of the app 304 to detect the activated trigger point. Upon detecting the disabled trigger point the trigger point is ignored and the app 304 execution goes uninterrupted. On detecting enabled trigger point the app 304 is interrupted. At 716, the application package 310 communicates with the server 106 to download the rule and the associated metadata including the payment plans. At 718, the rule is downloaded at evaluated locally on the electronic device 108. The payment options are displayed to the user and once the user 714 credits the amount, the app proceeds execution to further stages. The monitoring of the trigger point activation continues towards next trigger point.

However, the ISV 104 on analyzing the user trend may modify the rule and enable a changed monetization pattern for later time instants as be specified in the rule.

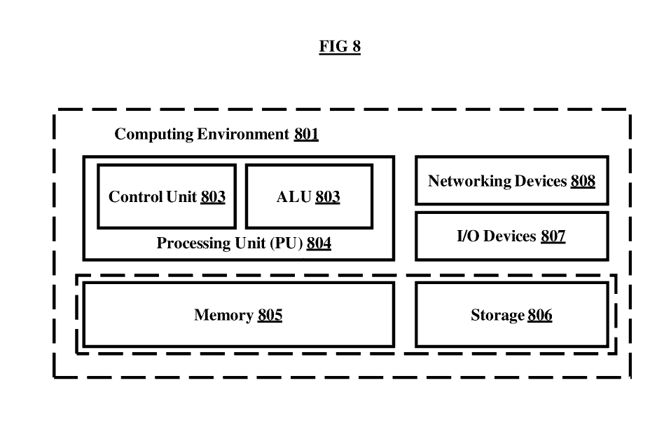

FIG. 8 illustrates a computing environment implementing the monetization platform allowing dynamic modification of the monetization pattern, according to embodiments disclosed herein. As depicted the computing environment 801 comprises at least one processing unit 804 that is equipped with a control unit 802 and an Arithmetic Logic Unit (ALU) 803, a memory 805, a storage unit 806, plurality of networking devices 808 and a plurality of input output (I/O) devices 807. The processing unit 804 is responsible for processing the instructions of the algorithm. The processing unit 804 receives commands from the control unit in order to perform its processing. Further, any logical and arithmetic operations involved in the execution of the instructions are computed with the help of the ALU 803.

The overall computing environment 801 can be composed of multiple homogeneous and/or heterogeneous cores, multiple CPUs of different kinds, special media and other accelerators. The processing unit 804 is responsible for processing the instructions of the algorithm. Further, the plurality of processing units 804 may be located on a single chip or over multiple chips.

The algorithm comprising of instructions and codes required for the implementation are stored in either the memory unit 805 or the storage 806 or both. At the time of execution, the instructions may be fetched from the corresponding memory 805 and/or storage 806, and executed by the processing unit 804.

In case of any hardware implementations various networking devices 808 or external I/O devices 807 may be connected to the computing environment to support the implementation through the networking unit and the I/O device unit.

The embodiments disclosed herein can be implemented through at least one software program running on at least one hardware device and performing network management functions to control the elements. The elements shown in the FIGS. 1 through 8 include blocks, component, units, modules, steps, or equivalent thereof which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for monetization of an application, the method comprising:
identifying at least one monetizing event in said application;
modifying at least one trigger point in said application based on said at least one identified monetizing event, wherein said at least one trigger point is associated with at least one rule to monetize said application in response to an activation of said at least one trigger point; and
building an application package including said at least one modified trigger point.

2. The method of claim 1, wherein said method comprises:
sharing said application package with at least one entity, wherein said at least one activates said at least one trigger point;
dynamically defining said at least one rule corresponding to said at least one trigger point in response to said activation; and
performing at least one action in accordance to said at least one rule.

3. The method of claim 2, wherein said at least one action is performed using an authorization component.

4. The method as in claim 1, wherein modifying said at least one trigger point based on said at least one identified monetizing event comprises at least one of:
enabling said at least one trigger point, disabling said trigger point, inserting said at least one trigger point, deleting said at least one trigger point, reordering said at least one trigger point, rewriting said at least one trigger point, remodeling said at least one trigger point, and altering said at least one trigger point.

5. The method of claim 1, wherein said at least one monetizing event in identified based on at least one parameter associated with said application, wherein said parameter comprises at least one of an application type, a content presented, a contextual datum that is associated with said content presented, a user interface element, and a user interface function.

6. The method of claim 1, wherein said application for monetization is received from a monetization component.

7. A system for monetization of an application, wherein said system comprises a server configured to:
identify at least one monetizing event in said application;
modify at least one trigger point in said application based on said at least one identified monetizing event, wherein said at least one trigger point is associated with at least one rule to monetize said application in response to an activation of said at least one trigger point; and
build an application package including said at least one modified trigger point.

8. The system of claim 7, wherein said server is configured to:
share said application package with at least one entity, wherein said at least one entity activates said at least one trigger point;
dynamically define said at least one rule corresponding to said at least one trigger point in response to said activation; and
perform at least one action in accordance to said at least one rule.

9. The system of claim 8, wherein said at least one action is performed using an authorization component.

10. The system of claim 7, wherein modifying said at least one trigger point based on said at least one identified monetizing event comprises at least one of:
enabling said at least one trigger point, disabling said trigger point, inserting said at least one trigger point, deleting said at least one trigger point, reordering said at least one trigger point, rewriting said at least one trigger point, remodeling said at least one trigger point, and altering said at least one trigger point.

11. The system of claim 7, wherein said at least one monetizing event is identified based on at least one parameter associated with said application, wherein said parameter comprises at least one of an application type, a content presented, a contextual datum that is associated with said content presented, a user interface element, and a user interface function.

12. The system of claim 7, wherein said application for monetization is received from a monetization component.

13. A server for monetization of an application, wherein said server is configured to:
identify at least one monetizing event in said application;
modify at least one trigger point in said application based on said at least one identified monetizing event, wherein said at least one trigger point is associated with at least one rule to monetize said application in response to an activation of said at least one trigger point; and
build an application package including said at least one modified trigger point.

14. The server of claim 13, wherein said server is configured to:
share said application package with at least one entity, wherein said at least one entity activates said at least one trigger point;
dynamically define said at least one monetization rule, corresponding to said at least one trigger point in response to said activation; and
perform at least one action in accordance to said at least one rule.

15. The server of claim 14, wherein said at least one action is performed using an authorization.

16. The server of claim 13, wherein modifying said at least one trigger point based on said at least one identified monetizing event comprises at least one of:
enabling said at least one trigger point, disabling said trigger point, inserting said at least one trigger point, deleting said at least one trigger point, reordering said at least one trigger point, rewriting said at least one trigger point, remodeling said at least one trigger point, and alternating said at least one trigger point.

17. The server of claim 13, wherein said server is configured to identify said at least one monetizing event based on at least one parameter associated with said application, wherein said parameter comprises at least one of an application type, a content presented, a contextual datum that is associated with said content presented, a user interface element, and a user interface function.

18. The server of claim 13, wherein said server is configured to receive said application for monetization from a monetization component.

19. A computer program product comprising computer executable program code recorded on a computer readable non-transitory storage medium, said computer executable program code when executed, causing the actions including:
identifying at least one monetizing event in said application;
modifying at least one trigger point in said application based on said at least one identified monetizing event, wherein said at least one trigger point is associated with at least one rule to monetize said application in response to an activation of said at least one trigger point; and
building an application package including said at least one modified trigger point.

20. The computer program product of claim 19, wherein said computer executable program code when executed, causing further actions including sharing said application package with at least one entity, wherein said at least one activates said at least one trigger point;
dynamically defining said at least one monetization rule corresponding to said at least one trigger point in response to said activation; and
performing at least one action in accordance to said at least one monetization rule.

21. The computer program product of claim 20, wherein said at least one action is performed using an authorization component.

22. The computer program product of claim 19, wherein modifying said at least one trigger point based on said at least one identified monetizing event comprises at least one of:
enabling said at least one trigger point, disabling said trigger point, inserting said at least one trigger point, deleting said at least one trigger point, reordering said at least one trigger point, rewriting said at least one trigger point, remodeling said at least one trigger point, and altering said at least one trigger point.

23. The computer program product of claim 19, wherein said at least one monetizing event in identified based on at least one parameter associated with said application, wherein said parameter comprises at least one of an application type, a content presented, a contextual datum that is associated with said content presented, a user interface element, and a user interface function.

24. The computer program product of claim 19, wherein said application for monetization is received from a monetization component.
